(19) United States
(12) Patent Application Publication
(10) Pub. No.: US 2025/0058922 A1
(43) Pub. Date: Feb. 20, 2025

(54) REUSABLE PLASTIC BOTTLE

(71) Applicant: ALPLA WERKE ALWIN LEHNER GMBH & CO. KG, Hard (AT)

(72) Inventor: Robert Siegl, Dornbirn (AT)

(21) Appl. No.: 18/721,169

(22) PCT Filed: Dec. 16, 2022
(86) PCT No.: PCT/EP2022/086307

§ 371 Date: Jun. 17, 2024

(30) Foreign Application Priority Data
Dec. 17, 2021 (CH) 070736/2021

(51) Int. Cl. B65D 1/02; B29C 49/00; B29K 67/00; B29K 105/00; B29K 105/16; B29K 511/00; C08K 11/00

(52) U.S. Cl. CPC B65D 1/0215; B29C 49/0005; C08K 11/00; B29K 2067/00; B29K 2105/0029; B29K 2105/16; B29K 2511/00

(57) ABSTRACT

The invention relates to a reusable plastic bottle for receiving a product, which bottle consists of a plastic material that absorbs odorous molecules from the product or from residues of the product. Coffee additives and/or coffee flavors are added to the plastic material, thereby reducing the penetration of odorous molecules into the plastic and reducing, masking or neutralizing off-odors of the odorous molecules.

### CROSS-REFERENCE TO RELATED APPLICATIONS

This application is a national phase entry under 37 U.S.C § 371 of PCT/EP2022/086307 filed Dec. 16, 2022, which claims priority to Swiss Patent Application No. 070736/2021 filed Dec. 17, 2021, the entirety of each of which is incorporated by this reference.

### FIELD OF THE INVENTION

The invention relates to a plastic bottle for receiving a product capable of absorbing odorous molecules from a product or from residues of the product and to a method for producing a plastic bottle for receiving a product capable of absorbing odorous molecules from a product or from residues of the product.

### PRIOR ART

Reusable bottles made of polyester must be partially deodorized prior to refilling. The reusable bottles are washed with an alkaline solution at 30 to 60° C. and refilled. At temperatures above 60° C., the bottles tend to change their shape (deformation) or to shrink too much. In addition, as the wash liquor temperature increases, the wash liquor used attacks the polyester more aggressively by saponifying the ester bond with the alkaline solution.

When polyester bottles are exposed to small odorous molecules (atomic mass unit of less than 350 daltons), these molecules migrate deep into the polyester matrix. The molecular components responsible for this can migrate into the product and directly affect the taste or odor of the product or indirectly affect the perceived taste of the product via the odor.

Penetration depends on the contact time, concentrations and temperature.

A washing process such as the one described above cannot completely remove the deeply penetrating molecules, as a result of which contaminated bottles can never be completely freed of the off-odors. When a reusable bottle is filled with a lemonade, limonene (136 daltons) penetrates the polyester material. If this bottle is refilled with mineral water, the limonene odor or the limonene taste is clearly perceivable and disturbs the consumer. In order to avoid off-odors or tastes, refillable polyester bottles are therefore only filled with the same product category, for example always refilled with lemonade or always with water. Alternatively, a plastic bottle contaminated with odors can be removed from the refilling process after testing with a so-called “electronic nose” by eliminating it according to the electronic nose. Reasons for removal are intense odors of gasoline, urine, mold, rancid milk, etc. Such penetration of odorous molecules into the polyester matrix occurs in particular after improper use of the bottle by the end user.

### ADVANTAGES OF THE INVENTION

The disadvantages of the described prior art lead to the invention of providing plastic bottles in which unpleasant odors, which are based on small molecules that have penetrated deep into the polymer matrix, are no longer perceptible to the consumer, or of providing plastic bottles that are not eliminated by the electronic nose, which is located either upstream of the bottle washing system or downstream of the bottle washing system.

Features are described below and are to be considered (individually) as advantageous or desired features, even if they are not explicitly referred to as such. The features may be disclosed separately as part of any plastic bottle or any desired method for producing a plastic bottle and, provided they are not mutually exclusive, in any combination. This includes the possibility of using device features to specify method features and vice versa.

### DETAILED DESCRIPTION OF THE INVENTION

The stated advantages for a bottle made of plastic material is achieved by the features stated in the independent claims. Developments and/or advantageous alternative embodiments form the subject-matter of the dependent claims.

The invention is directed to coffee additives or coffee flavors added to the plastic material, thereby reducing the penetration the odorous molecules into the plastic material and reducing, masking, or neutralizing off-odors of the odorous molecules.

Therefore, coffee or, in particular, components obtained from roasted coffee, coffee or, in particular, components obtained from roasted coffee, in particular, coffee flavors or roasted flavors, or other components of the coffee beans themselves are added to the plastic.

These components include triglycerides, diterpene esters, diterpenes, triterpene esters, triterpenes and caffeine, as can be seen from the table below.

TABLE 21.5
Composition of the lipid fraction of the roasted coffee (coffee oil)

| Component | Amount (%) |
|---|---|
| Triglycerides | 78.8 |
| Diterpene esters | 15.0 |
| Diterpenes | 0.12 |
| Triterpene esters | 1.8 |
| Triterpenes (sterols) | 0.34 |
| Unknown substances | 4.0 |

Lehrbuch der Lebensmittelchemie ISBN 978-3-540-73201-3, page 974

It is disadvantageous that the use of roasted coffee additives leads at least partially to a reduction in the viscosity of the polyester. This reduction in the intrinsic viscosity can be measured up to 0.6 dl/g according to ASTM D4603.

According to the following table, the roasted flavors include:

TABLE 21.7
Flavors from roasted coffee - result of dilution analyses
Flavor

Acetaldehyde, methanethiol, propanal, methylpropanal, 2-/3-
methylbutanal, 2,3-butanedione, 2,3-pentanedione, 3-methyl-2-butene-1-
thiol, 2-methyl-3-furanethiol, 2-furfurylthiol, 2-/3-methylbutyric acid,
methional, 2,3,5-trimethylthiazole, trimethylpyrazine, 3-mercapto-3-
methyl-1-butanol, 3-mercapto-3-methylbutyl formate, 2-(1-
mercaptoethyl)-furan, 2-methoxy-3-isopropylpyrazine, 5-ethyl-2,4-di-
methylthiazole, 2-ethyl-3,5-dimethylpyrazine, phenyl acetaldehyde, 2-
ethenyl-3,5-dimethylpyrazine, linalool, 2,3-diethyl-5-methylpyrazine, 3,4-
dimethyl-2-cyclopentenol-1-on, guaiacol, 4-hydroxy-2,5-dimethyl-3(2H)-
furanone, 3-isobutyl-2-methoxypyrazine, 2-ethenyl-3-ethyl-5-
methylpyrazine, 6,7-dihydro-5-methyl-5H-cyclopentapyrazine, (E)-2-
nonenal, 5-ethyl-4-hydroxy-2-methyl-3(2H)furanone, 3-hydroxy-4,5-
dimethyl-2(5H)-furanone, 4-ethylguaiacol, p-anisaldehyde, 5-ethyl-3-
hydroxy-4-methyl-2(5H)-furanone, 4-vinylguaiacol, (E)-β-damascenone,
bis(2-methyl-3-furyl)disulfide, vanillin

Lehrbuch der Lebensmittelchemie ISBN 978-3-540-73201-3, page 975

Coffee additives should also be understood to mean waste or unusable components of coffee or coffee beans. For example, the roasting process produces fractions, so-called shells and skins, which can be used in the manner according to the invention. In the case of decaffeinated coffee, the caffeine is formed as a waste product and coffee grounds are formed after the coffee preparation. All of these coffee components can be used in the manner according to the invention by incorporating them into the plastic material.

The coffee components is to be added to the polyester in such a way that, at least for the consumer, no coffee or roasted flavor is deliberately perceivable, and the electronic nose has stored this odor component as desired.

Surprisingly, the odors (molecules smaller than 350 daltons) associated with bad or undesirable tastes thereby penetrate significantly less into the material, which is also clearly detectable by the electronic nose. More importantly, however, the human nose does not seem to perceive these odors (molecules smaller than 350 daltons) any more or much less, although it is unclear whether this is due to neutralization or masking of the odors.

Roasted coffee for neutralizing odors is, like vinegar, a known a household remedy. The reduced absorption of the odorous molecules in the case of refillable bottles is, however, absolutely surprising and has hitherto not been recognized in other applications.

As is stated in the prior art, molecules that have penetrated deep into the plastic material and produce unpleasant odors can often no longer be removed by washing processes. Surprisingly, components of coffee can affect such odors such that they are no longer perceptible or are only more peripherally perceptible. Bottles can thereby be refilled with different beverages without having to consider whether it was previously filled with an odorous product, or whether the bottle could affect the consumer with odor nuisances for other reasons.

Even if some odorant exposure cannot be avoided, it is reduced or occurs only after many more cycles of the bottle, ensuring that the bottle can go through more cycles before the electronic nose eliminates it.

The addition according to the invention of the coffee additives has the advantage that almost all odors can no longer penetrate as intensively into the polymer matrix and can no longer be released as strongly therefrom, as well as the advantage that the remaining odors can no longer be perceived by the consumer in this intensity. This is often referred to as a neutralizing effect of the coffee or coffee flavor.

In this case, it is irrelevant whether off-odors are covered up or neutralized. What is important is that the consumer can no longer perceive them olfactorily, or can perceive it less.

By adding coffee additives, it is not necessary to always fill the same beverage into the reusable bottle, but it is possible to change the beverage type, since any unpleasant odor of a beverage that cannot be 100% removed by cleaning the reusable bottle is influenced or neutralized by the roasted flavors of the coffee. In addition, the penetration of the odorous molecules into the polymer matrix is reduced.

In one embodiment of the invention, the plastic bottle is designed in one layer from a plastic material with coffee additives and/or coffee flavors. In another embodiment, the plastic bottle is multi-layered, at least the inner layer, i.e., the layer that is in contact with the product, consisting of a plastic material to which coffee additives and/or coffee flavors are added. This is essential to prevent the coffee additives and/or coffee flavors from transferring a negative taste from the product to the inner layer.

In another embodiment of the invention, the coffee additives may be present in the plastic material by introducing roasted coffee or waste from coffee production in a free-flowing form or liquid coffee extract from roasted coffee or from waste from coffee production as extraction material into the plastic material. These two types of coffee additives reliably seal the polyester against new odors so that they penetrate less strongly into the polymer and influence the residual release into the product or the headspace above the product, so that the consumer does not perceive this as annoying.

It has proven expedient if the coffee additive is ground coffee beans or waste from coffee production having a particle size between 50 and 1000 nm and is added to the plastic material in an amount between 0.1 and 5 wt. %. The additive can be produced quickly and inexpensively, and small amounts are sufficient to achieve the desired effect of odor reduction.

The coffee extract is expediently obtained by extracting heated oil or other fluid with finely ground coffee beans and is added to the plastic as an oil or fluid extract in an amount between 0.1 and 2 wt. %. The heated oil used as an extraction agent can be, for example, rapeseed oil at 120° C. The oil extract is distributed particularly easily and uniformly in the plastic. It is also conceivable for the extraction agent to be water-based. However, the extract must be dehydrated before it is added to the plastic because water destroys (hydrolyzes) the polyester.

Advantageously, the coffee additives introduced into the plastic material have a water content of at most 2000 ppm. As stated in the last paragraph, only a virtually anhydrous coffee component can be incorporated into the polyester without hydrolyzing the polyester.

The invention may further comprise additional pure caffeine is introduced into the plastic material in addition to the caffeine contained in the coffee additives. The additional caffeine has the effect that the penetration of odorous molecules of less than 350 daltons, such as limonene, acetaldehyde, formaldehyde, butyric acid, or valeric acid is significantly reduced. Therefore, the odor load of a bottle is significantly reduced from the outset, and the roasted flavor of coffee only needs to mask or neutralize lower odor concentrations.

In another embodiment of the invention, the bottle is colored by the added coffee additives. The discoloration caused by the coffee is used as a UV and light barrier. This discoloration is brownish or yellowish. As a result, a bottle with a coffee additive automatically has very good UV and light protection, which prevents degradation reactions of vitamin B2 in the product, for example milk. This degradation reaction of vitamin B2, which leads to very unpleasant odors, can be significantly reduced by the coloring.

It has proven to be advantageous if the odorous molecules comprise limonene, acetaldehyde, formaldehyde, lactic acid, valeric acid or butyric acid. These molecules, which are regularly found in the product, can penetrate deep into the polymer matrix of the plastic bottle. Surprisingly, it was found that these molecules are less able to penetrate the polymer matrix and the roasted flavor of the coffee can neutralize the very unpleasant odors that are still present. As a result, the bottle can be refilled without the consumer perceiving the odors of the molecules.

The plastic is expediently a polyester compound, in particular PET, PEF, PEN or polyspiro alcohol polyester. The principle of action of the coffee additive can thereby be used in all common reusable bottles made of polyester.

The plastic may also be a polyolefin, in particular PE, PP, or COC, as a result of which the functional principle of the coffee additive can also be used in all common reusable bottles made of polyolefins.

In an advantageous embodiment of the invention, the polyester compound has an intrinsic viscosity of between 0.84 dl/g and 1.40 dl/g according to ATM D4603. Compared to polyester compounds, which are typically used in the manufacture of disposable plastic bottles, the present polyester compound has an increased intrinsic viscosity. This compensates for the negative effect of the roasted coffee additives, which cause a significant degradation of the polyester molecules.

In a further advantageous embodiment of the invention, the polyester compound has chain extenders. This also compensates for the negative effect of the coffee components, which causes a significant degradation of the polyester molecules.

A polyfunctional anhydride, i.e., a molecule with two or more anhydride groups, may be used as a chain extender.

In another embodiment of the invention, tetracarboxylic dianhydrides may be used as chain extenders.

In a further embodiment pyromellitic dianhydride can be used as a chain extender.

In addition, one of the following chain extenders can be used as chain extenders: bisoxazolines, bisepoxides, diisocyanates, polyepoxides, a plurality of compounds bearing glycidyl groups, maleic anhydride, phthalic anhydride, triphenyl phosphates, lactamyl phosphites, ciclo-phosphazene, polyacyl lactam, along with bis-2-oxazolines, bis-5,6-dihydro-4h-1,3-oxazines, diisocyanates, trimethyl 1,2,4-benzenetricarboxylate (trimethyltrimellitate, TMT), carbonyl bis (1-caprolactam).

It has been found that the use of coffee additives and/or coffee flavors, and possibly the use of a higher viscosity polyester and the use of chain extenders in the case of reusable containers, is expedient because reusable bottles are used for numerous fills and have a longer service life than disposable containers.

It is advantageous if the plastic is PET, but the effect of the coffee flavors is also relevant for PP and PE, in particular HDPE or LDPE. As a result, the odor neutralization or masking can be used not only in polyester bottles, but also in bottles made of polypropylene or polyethylene.

A further aspect of the invention relates to a method for producing a reusable plastic bottle according to the above description. In principle, the bottle is produced after stretch blow molding of an injection-molded preform. The preform is produced by molding an extruded polyester in an injection mold. During the filling of the extruder, coffee additives and/or coffee flavors are added to the polyester. In this way, the addition of the coffee additives during each extrusion to produce a preform can be supplemented with little effort.

1. A reusable plastic bottle for receiving a product, comprising:
a bottle comprised of a plastic material capable of absorbing odorous molecules from the product or from residues of the product,
the plastic material of the bottle comprising coffee additives and/or coffee flavors added to the plastic material to reduce, mask, or neutralize off-odors of odorous molecules of the product that penetrate or reside on the plastic material.

2. The plastic bottle according to claim 1, wherein the plastic bottle comprises a single layer of the plastic material with coffee additives and/or coffee flavors.

3. The plastic bottle according to claim 1, wherein the plastic bottle is multi-layered, and wherein at least a layer that is in contact with the product comprises the plastic material with coffee additives and/or coffee flavors.

4. The plastic bottle according to claim 1, wherein the coffee additives are present in the plastic material by introducing roasted coffee or waste from coffee production in a free-flowing form or liquid coffee extract from roasted coffee or from waste from coffee production as extraction material into the plastic material.

5. The plastic bottle according to claim 1, wherein the coffee additives comprise ground coffee beans or waste from coffee production having a particle size between 50 and 1000 nm and that is added to the plastic material in an amount between 0.1 and 5 wt. %.

6. The plastic bottle according to claim 1, wherein the coffee extract is obtained by extracting heated oil or other fluid with finely ground coffee beans and is added to the plastic material as an oil or fluid extract in an amount between 0.1 and 2 wt. %.

7. The plastic bottle according to claim 1, wherein the coffee additives introduced into the plastic material have a water content of at most 2000 ppm.

8. The plastic bottle according to claim 1, further comprising pure caffeine in the plastic material in addition to caffeine contained in the coffee additives.

9. The plastic bottle according to claim 1, wherein the bottle is colored by the coffee additives.

10. The plastic bottle according to claim 1, wherein the odorous molecules comprise at least one of limonene, acetaldehyde, formaldehyde, lactic acid, valeric acid or butyric acid.

11. The plastic bottle according to claim 1, wherein the plastic material is a polyester compound, PET, PEF, PEN, or a polyspiro alcohol polyester.

12. The plastic bottle according to claim 1, wherein the plastic material is a polyolefin, PE, PP, or COC.

13. The plastic bottle according to claim 11, wherein the polyester compound has an intrinsic viscosity of between 0.84 and 1.4 dl/g according to ATM D4603.

14. The plastic bottle according to claim 11, wherein the polyester compound has chain extenders.

15. The plastic bottle according to claim 14, wherein a polyfunctional anhydride, a molecule having two or more anhydride groups, is used as a chain extender.

16. The plastic bottle according to claim 14, wherein tetracarboxylic acid dianhydrides are used as chain extenders.

17. The plastic bottle according to claim 14, wherein pyromellitic dianhydride is used as a chain extender.

18. The plastic bottle according to claim 14, wherein bisoxazolines, bisepoxides, diisocyanates, polyepoxides, a plurality of compounds bearing glycidyl groups, maleic anhydride, phthalic anhydride, triphenyl phosphates, lactamyl phosphites, ciclo-phosphazene, polyacyl lactam, along with bis-2-oxazolines, bis-5,6-dihydro-4h-1,3-oxazines, diisocyanates, trimethyl 1,2,4-benzenetricarboxylate (trimethyltrimellitate, TMT), carbonyl bis (1-caprolactam) are used as chain extenders.

19. A method for producing a reusable plastic bottle, comprising the following steps:
a) filling an extruder with a polyester,
b) adding coffee additives and/or coffee flavors to the polyester when the extruder is filled,
c) extruding the polyester and feeding the polyester into a molding tool of an injection molding machine,
d) forming a preform,
e) heating the preform to a temperature of 30 to 50° Celsius above the glass transition temperature of the polyester used,
f) feeding the heated preform into a blow molding tool of a blow molding machine,
g) blowing and stretching a plastic bottle, and
h) ejecting the plastic bottle from the blow molding tool.
